(19) United States
(12) Patent Application Publication
(10) Pub. No.: US 2005/0203935 A1
(43) Pub. Date: Sep. 15, 2005

(54) Clipboard content and document metadata collection

(75) Inventor: James Michael McArdle, Austin, TX (US)

Correspondence Address: Gregory K. Goshorn;Hulsey Grether Fortkort + Webster, LLP, Suite 3200, 8911 N. Capital of Texas Hwy., Austin, TX, 78759, US

(73) Assignee: INTERNATIONAL BUSINESS MACHINES CORPORATION, ARMONK, NY (US)

(21) Appl. No.: 10/798,904

(22) Filed: Mar. 11, 2004

(51) Int. Cl. G06F 17/00

(52) U.S. Cl. 707/101

(57) ABSTRACT

Provided is a system and method for the collection and storing of information relating to a document captured in a copy-and-paste operation of a word processing application, spreadsheet, presentation processing software or other application that provides copy-and-paste functionality. A clipboard interface collects and stores information, or “metadata,” relating to a selected document or portion of a document. Once the metadata collection system gathers information corresponding to particular captured content, the system stores the information as metadata so that the user or a subsequent user of the destination document can, when necessary, access the metadata associated with the source document. Metadata is stored either within the destination document or in another document that can be correlated with the destination document.

### TECHNICAL FIELD

The present invention relates generally to document processing functionality and, more specifically, to a system and method for collecting and storing metadata in conjunction with clip and paste operations associated with document processing applications.

### BACKGROUND OF THE INVENTION

Several types of software found on many computing systems are word processing applications, spreadsheets and presentation processing software such as Microsoft (MS) Word, MS Excel and MS Powerpoint, respectively, all published by the Microsoft Corporation of Redmond Calif. Other examples of document processing applications include various Lotus software programs published by International Business Machines Corp. (IBM) of Armonk, N.Y. Typically, these applications provide a “clipboard” function that enables a user to select a portion of a document, save that portion to memory and, then, copy, or “paste,” that portion into another document or into a different position in the same document. Text selection functionality is also referred to as “cutting,” copying” or “clipping” text. Often, “copy-and-paste” functionality is provided in conjunction with “drag-and-drop” features of graphical user interfaces (GUIs).

Copy-and-paste functionality is especially useful for creating a document that relies upon other documents for content. For example, a student can research a subject with the aid of an Internet search engine, copy relevant portions of a particular reference source and paste that portion into a term paper, thus eliminating unnecessary typing. One issue that arises in this context is the need to attribute the copied content to a particular source. Often, a user who captures material to write a paper, email a message or create a presentation must be aware of where the material originates and provide appropriate recognition to the originator, particularly if the material is copyrighted.

Current applications that provide copy-and-paste functionality require the user to manually record information corresponding to the source material, either during or soon after the copy-and-paste operation. This information related to the source document, called “meta information” or “metadata,” may include such information as the date and time of capture, name of the source document, position within the source document and a website or universal source locator (URL) where the source document can be located. In the case of a website or URL, there is no guarantee that a particular document remains available over time as websites may change with respect to their content.

### SUMMARY OF THE INVENTION

Provided is a system and method for the collection and storing of information relating to a document captured in a copy-and-paste operation of a word processing application, spreadsheet, presentation processing software or other application that provides copy-and-paste functionality. A clipboard interface collects and stores information, or “metadata,” relating to a selected document or portion of a document, hereinafter referred to as the “captured content.” Metadata may include, but is not limited to, the date and time the captured content is copied, a source filename or document, a line number or byte offset within the source document corresponding to the original location of the captured content and the size of the captured content. Other examples of collected metadata may include the title and author of the source document, a release or version number, a URL, the date and time the source document was created, the data and time the captured content is pasted into a destination document, the source host name, the source domain name and a source Internet Protocol (IP) address. Captured content may include, but is not limited to, text, graphics, URLs, email addresses and programming source code.

Once the metadata collection system gathers information corresponding to particular captured content, the system stores the information as metadata so that the user or a subsequent user of the destination document can, when necessary, access the metadata associated with the source document. This feature enables the user or a subsequent user to properly attribute the captured information to the person or entity that created the captured content. Recent events have demonstrated the need to document the source of material captured from sources such as the Internet. For example, it is often important for a programmer who copies software code from an external source to acknowledge the source. In addition, it may become necessary for the programmer to provide proof that a particular code was not copied from an unauthorized source. The claimed subject matter provided this capability.

Metadata is stored either within the destination document or in another document that can be correlated with the destination document. If stored within the destination document, metadata can be either hidden in non-viewable areas of the document or in viewable areas, such as in a footnote. If stored in a separate, correlated document, the separate document can be assigned the same name as the destination document with a different file extension that identifies the contents of the separate document as containing metadata.

### BRIEF DESCRIPTION OF THE DRAWINGS

A better understanding of the present invention can be obtained when the following detailed description of the disclosed embodiments is considered in conjunction with the following drawings, in which:

FIG. 1 is a block diagram of an exemplary system architecture that supports the claimed subject matter;

FIG. 2 is an illustration of a display screen of FIG. 1 with an exemplary, active web browser application;

FIG. 3 is an illustration of a web browser window of FIG. 2 displaying a source document, with a portion of the source document highlighted indicating the portion is a potential target of an action;

FIG. 4 is an illustration of the web browser window of FIGS. 2 and 3 with a target document displayed;

FIG. 5 is a diagram of an exemplary memory object employed to implement the claimed subject matter; and

FIG. 6 is a flowchart of a Copy Plus and Paste process that implements the claimed subject matter.

### DETAILED DESCRIPTION OF THE FIGURES

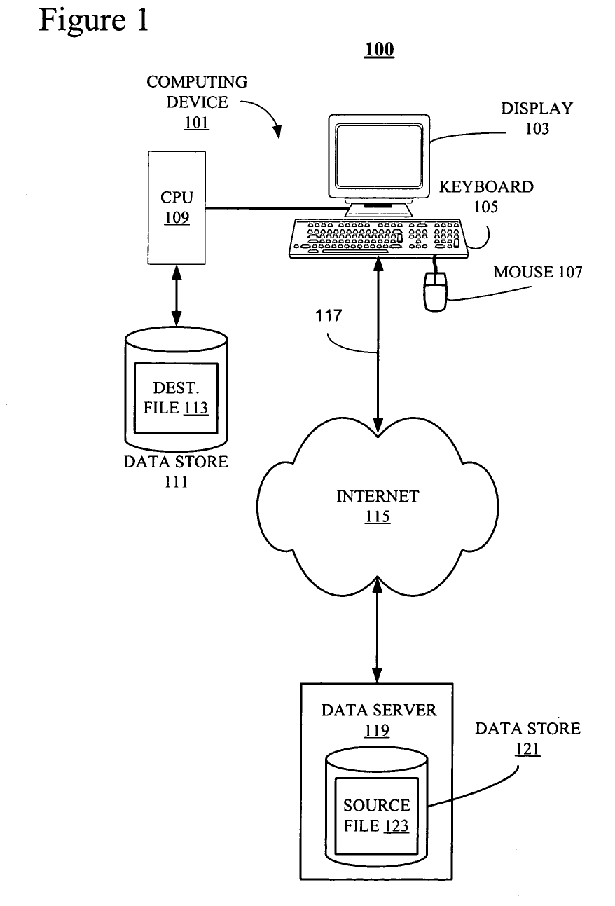

Although described with particular reference to word processing software, the Copy Plus and Paste system and method of the current invention can be implemented in any application that provides cut-and-paste or copy-and-paste, i.e. “clipboard,” functionality. For example, other suitable applications include, but are not limited to, spreadsheets, graphic programs, email programs and presentation processing applications. FIG. 1 illustrates an exemplary architecture 100 in which the system according to the present invention is implemented. Those with skill in the computing arts will recognize that the disclosed embodiments have relevance to a wide variety of applications and architectures in addition to those described below. In addition, the augmented clipboard functionality of the present invention can be implemented in software, hardware, or a combination of software and hardware. The hardware portion can be implemented using specialized logic; the software portion can be stored in a memory or recording medium and executed by a suitable instruction execution system such as a microprocessor.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory an recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

FIG. 1 is a block diagram of an exemplary system architecture 100 that supports the claimed subject matter. System 100 includes a computing device 101, which in this example is a personal computer (PC). Attached to PC 101 are a display 103, a keyboard 105, and a mouse 107. Display 103, keyboard 105 and mouse 107 provide a user with means to interact with PC 101. Also included in PC 101 are a central processing unit (CPU) 109 and a recording medium, or data store 111. Those with skill in the computing arts should be familiar with PC 101 and related components 103, 105, 107, 109 and 111.

PC 101 is connected to the Internet 115 via a connection 117. Also coupled to Internet 115 is a data server 119 with a data store 121. A user of PC 101 can access various information sources, such as a source file 123 on data store 119, via Internet 115. For example, source file 123, may contain the contents of a novel that the user is using to write a book report. The user's book report is represented as a destination file 113 on data store 111. The current invention enables the user to collect and store information, or metadata, concerning the novel, collected from source file 123 and data server 119, necessary to provide proper attribution in book report 113. The metadata (not shown) may be stored either in a visible or non-visible manner within file 113 or, in the alternative, in a second file (not shown) on data store 111. For example, if the book report 113 is stored as a Microsoft Word document entitled “Book Report.doc” then the corresponding metadata may be stored as a file entitled “Book Report.mta.” In this manner, it is easy to correlate a Word document with the corresponding metadata file.

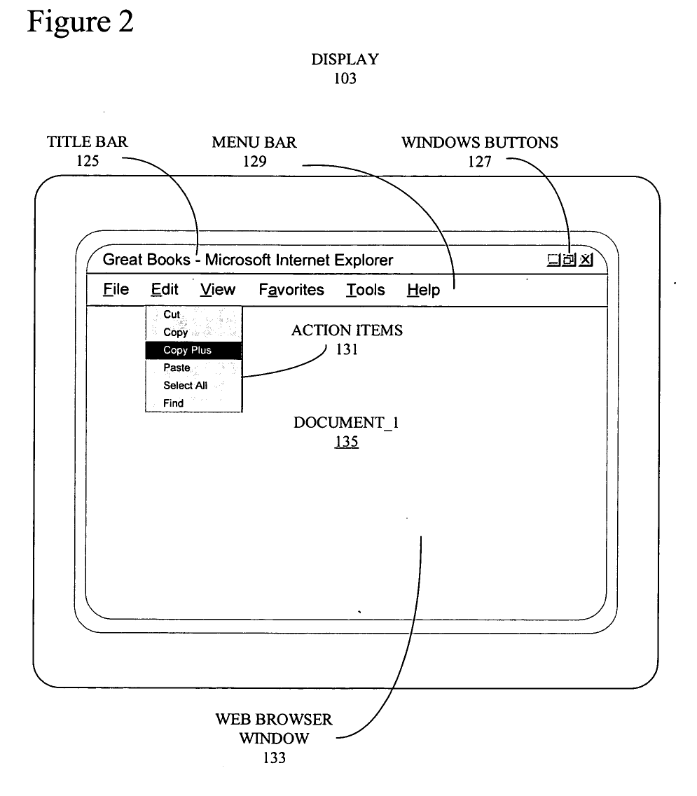

FIG. 2 is an illustration of display 103 of FIG. 1 in more detail. In this view, display screen 103 is shown with an exemplary, active web browser application. A title bar 125 lists the name of a displayed web site, or “Great Books,” and the particular web browser used in this example, or Microsoft Internet Explorer, published by the Microsoft Corporation. As is typical in web browsers, title bar 125 includes several windows buttons 127, or a “Minimize” button, a “Restore” button and an “Exit” button. Below title bar 125 is a menu bar 129, which includes a “File” option, “Edit” option, “View” option, “Favorites” option, “Tools” option and “Help” option. Microsoft Internet Explorer, as well as web browsers in general, should be familiar to those with skill in the art.

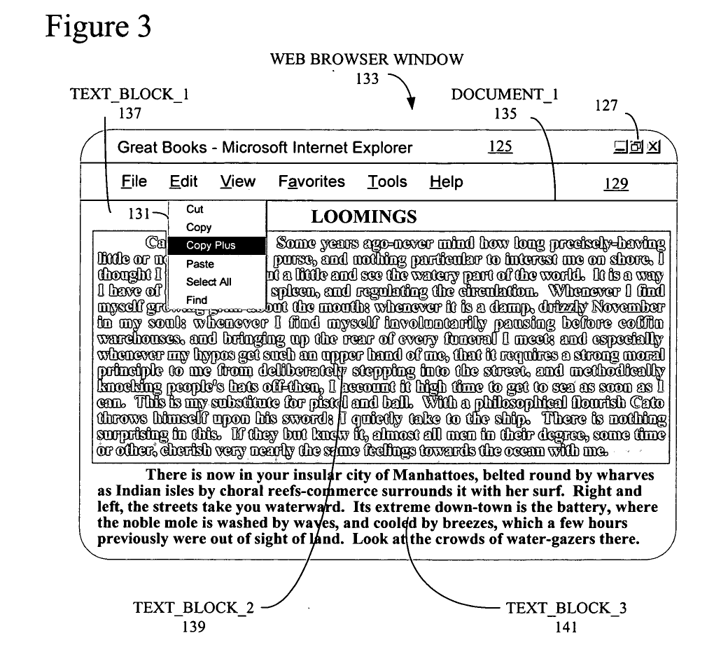

In this example, the Edit option of menu bar 129 is expanded to display several Action Items 131, including a “Cut” action, “Copy” action, “Copy Plus” action, “Paste” action, “Select All” action and “Find” action. Copy Plus action, which is highlighted in action items 131, initiates a claimed, enhanced copy-and-paste operation of the present invention, which is described in more detail below in conjunction with FIGS. 3-6. Finally, a document_{—}1 135, which is shown in more detail below in conjunction with FIG. 3, is displayed within a web browser window 133.

FIG. 3 is an illustration of web browser window 133 of FIG. 2 in more detail, displaying an exemplary source document, in this example, document_{—}1 135 (FIG. 2). In this example, the text of document_{—}1 135, retrieved via Internet 115 from source file 123 (FIG. 1) on data store 121 of data server 119, is stored as cache file (not shown) on data store 111 of computing system 101, shown in FIG. 1

Document_{—}1 135 is the beginning of the novel “Moby Dick” and is divided into three sections, a Heading section, or text_block_{—}1 137, a second portion, or text_block_{—}2 139, and a third portion, or text_block_{—}3 141. Text_block_{—}2 139 is highlighted, indicating that this particular portion of document_{—}1 135 has been selected as the target of one of action items 131. The highlighting of text_block_{—}1 139 is performed by positioning a cursor (not shown) at the beginning of text_block_{—}1 139, holding down a left button (not shown) of mouse 107 (FIG. 1), moving mouse 107 so that the cursor is positioned over the end of text_block_{—}2 139, and then releasing the left button of mouse 107. This type of highlighting operation, often referred to as “text marking” or “text selection,” should be familiar to those with experience with one of the Windows operating systems published by Microsoft Corporation. Title bar 125, windows buttons 127, menu bar 129, and action items 131 are the same as shown above in conjunction with FIG. 2.

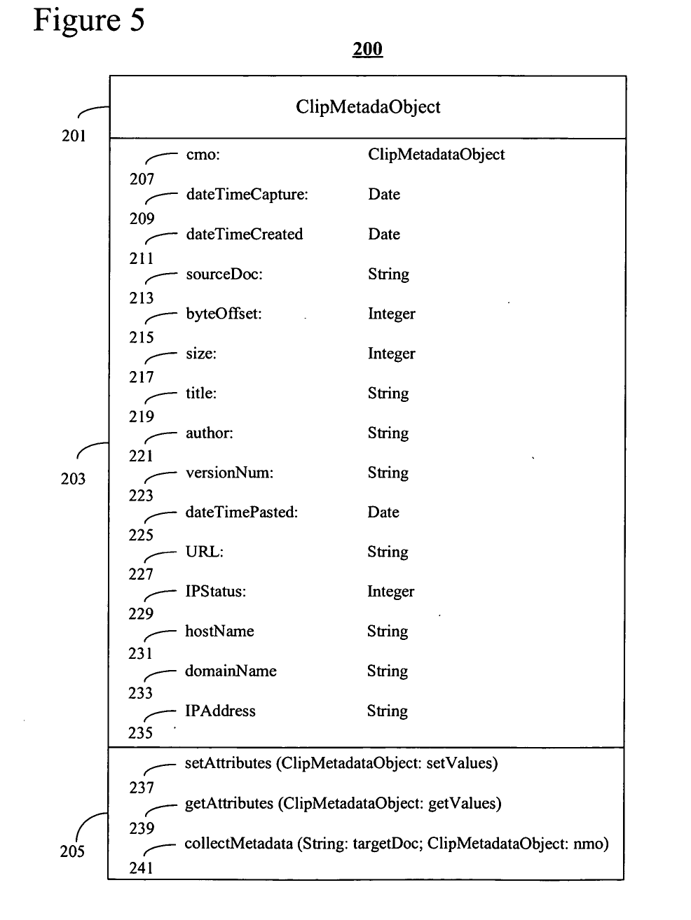

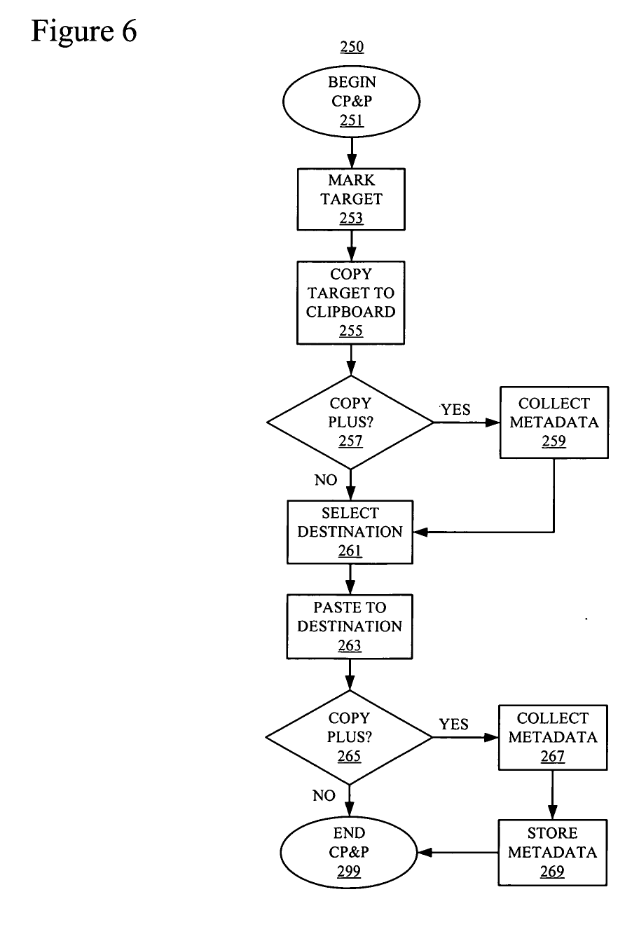

If a user clicks on the Copy action of action buttons 131 with mouse 107, the highlighted portion of document_{—}1 135, or text_block_{—}2 139, is copied either into memory (not shown) of CPU 109 (FIG. 1) or into data store 111 in a section called the “clipboard” (not shown). If the user clicks on the Copy Plus action of action buttons 131, the same actions are executed as when the Copy button is clicked, but, in addition, other procedures that collect and store metadata relating to the highlighted portion of document_{—}1 135 are also executed. Metadata is explained in more detail below in conjunction with FIG. 5. The capture and storage of the metadata performed in conjunction with the Copy Plus action button is explained in more detail below in conjunction with FIG. 6.

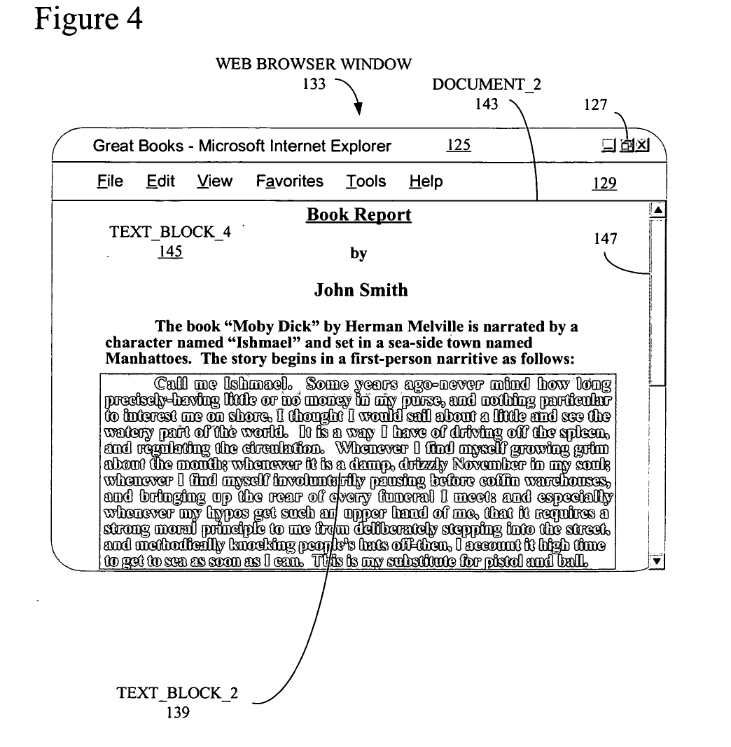

FIG. 4 is an illustration of web browser window 133 of FIGS. 2 and 3 with an exemplary target document, or document_{—}2 143, displayed. Document_{—}2 143 is a book report on the novel “Moby Dick” and is stored on computing system 101 (FIG. 1) as destination document 113 (FIG. 1). Web browser window includes title bar 125, windows buttons 127 and menu bar 129, as shown above in conjunction with FIGS. 2 and 3. Since, in this view, document_{—}2 143 is too long to fit into web browser window 133, a slider bar 147 is provided to enable the user to view various portions of document_{—}2 143 that are currently obscured.

Document_{—}2 143 is divided into two parts, a text_block_{—}4 145 and text_block_{—}2 139. Text_block_{—}4 145 has been entered by the user and represents the beginnings of the book report on “Moby Dick.” Text_block_{—}2 139 is copied, or “pasted,” into document_{—}2 143 from the clipboard, which is described above in conjunction with FIG. 3. The paste of text_block_{—}2 139 is executed when the user clicks on Paste action of action buttons 131 following the execution of either the Copy action or the Copy Plus action on text_block_{—}2 139.

When Paste action of action buttons 131 is executed after the Copy Plus action, additional steps are performed in order to collect and store metadata related to document_{—}1 135 (FIGS. 2 and 3) and text_block_{—}2 139. The additional steps and a memory object used to implement the steps are described below in conjunction with FIGS. 5 and 6.

FIG. 5 is a diagram of an exemplary ClipMetaData memory object 200 that is employed to implement the Copy Plus functionality of the claimed subject matter. A first section 201 of memory object 200 defines the name of class 200, or “ClipMetadataObject.” A second section 203 defines attributes of ClipMetadataObject 200 and a third section 205 defines a few exemplary methods of ClipMetadataObject 200.

In this example, attribute section 203 of object 200 includes a “cmo” attribute 207,” “dateTimeCapture” attribute 209, “dateTimeCreated” attribute 211, “sourceDoc” attribute 213, “byteOffset” attribute 215, “size” attribute 217, “title” attribute 219, “author” attribute 221, “versionNum” attribute 223, “dateTimePasted” attribute 225, “URL” attribute 227, “IPStatus” attribute 229, “hostname” attribute 231, “domainName” attribute 233 and “IPAddress” attribute 235. Attributes 207, 209, 211, 213, 215, 217, 219, 221, 223, 225, 227, 229, 231, 233 and 235 will described below in terms of text documents such as document_{—}1 135 and document_{—}2 143 (FIG. 4), although, it should be noted that the claimed subject matter applies to a wide variety of types of content. In fact, different types of content may require memory objects different than object 200 in order to record metadata that reflects the nature of any particular content. In other words, object 200 is used merely as an example of one of the types of memory objects that may necessary to implement the claimed subject matter.

Cmo attribute 207 is a variable of type ClipMetadataObject that contains the attributes and methods to enable an instance of object 200. DateTimeCapture attribute 209 is a variable of type Date that stores information relating to the time and date that the corresponding content was captured, or copied. For example, if a user located and copied document_{—}1 135 on Dec. 15, 2003 at 3:00 PM, then attribute 209 would store that information. SourceDoc attribute 211 is a variable of type String that stores information corresponding to the document from which text_block_{—}2 139 (FIGS. 3 and 4) was copied. In this example, attribute 211 contains the string “Moby Dick.doc,” which is the name of source file 123 (FIG. 1), which contains the text from which text_block_{—}2 139 was copied. DateTimeCreated attribute 213 is a variable of type String that stores information relating to the date and time source document 123 was created.

ByteOffset attribute 215 is a variable of type Integer that stores information corresponding to a location within the source document, i.e. document_{—}1 135, where the captured content, i.e. text_block_{—}2 139, is located. For example, if variable 213 is expressed in terms of paragraphs, then variable 213 is set to a value equal to ‘2’. If variable 215 is expressed in terms of bytes, then variable 215 is set to a value equal to ‘9’. Size attribute 217 is a variable of type Integer that stores information indicating the size of the captured content. In the case of text_block_{—}2 139, if the size is expressed in terms of bytes of memory, then attribute 217 is set to a value equal to ‘1,108’.

Title attribute 219 is a variable of type String that stores information relating to the title of the captured content, which in this example is “Moby Dick.” Author attribute 221 is a variable of type String that stores information relating to the author of the captured content, which in this example is “Herman Melville.” VersionNumber attribute 223 is a variable of type string that stores information relating to any version or release number associated with the captured content. In this example, there is no version number so attribute 223 is set to a value of “NULL.” DateTimePasted attrribute 225 is a variable of type Date that stores information indicating when text_block_{—}2 139 is pasted into document_{—}2 143. For example, if text_block_{—}2 139 is pasted one minute after it is copied, then attribute 225 is set equal to a value of “Dec. 15, 2003; 3:01 PM.”

URL attribute 227 is a variable of type String that stores information to a URL, if applicable, representing the location source file 123. In this example, attribute 227 is set to a value of “http://www.GreatBooks.com/MobyDick.html.” IPStatus attribute 229 is a variable of type Integer that stores information pertaining to the intellectual property (IP) status of document_{—}1 135. In this example, because the novel “Moby Dick” is in the public domain, attribute 229 is set to value that represents a code indicating text_block_{—}2 139 may be used without the payment of royalties.

HostName attribute 231 is a variable of type String that stores information relating to the host name of the computer 119 on which source document 123 is stored and located. DomainName attribute 233 is a variable of type String that stores information relating to the Internet domain name of data server 119. IPAddress attribute 235 is a variable of type String that stores information relating to the IP address of data server 119.

A third section 205 of ClipMetaObject object 200 includes functions, or, in object oriented terminology, “methods,” of object 200, i.e. a “setAttributes” method 237, “getAttributes” method 239 and “collectMetadata” method 241. Each of methods 237, 239 and 241 has an argument of type ClipMetaObject. SetAttributes method 237 enables a user or program to store designated values in attributes 207, 209, 211, 213, 215, 217, 219, 221, 223, 225, 227, 229, 231, 233 and 235 of an instance of ClipMetaObject object 200 represented by method's 237 argument setValues. GetAttributes method 239 enables a user or program to retrieve designated values for attributes 207, 209, 211, 213, 215, 217, 219, 221, 223, 225, 227, 229, 231, 233 and 235 of an instance of ClipMetaObject object 200 represented by method's 239 argument getvalues.

CollectMetadata method 241 is called when a user clicks on either the Copy Plus or Paste actions of action items 131 (FIGS. 2 and 3). Method 241 creates a new instance of ClipMetaObject object 200, if necessary, collects the information to populate the attributes of object 200, and then calls setattributes method 237 in order to populate the fields of the corresponding object 200.

The values of many attributes, such as attributes 207, 209, 213, 215, 217, 225, 227, 231, 233 and 235 can be easily determined by method 241 at the time method 241 is called. Other attributes, such as 211, 219, 221, 223 and 229 may take additional methods to determine appropriate values. For example, in order to determine a value for IPStatus attribute 229, source file 123 may be scanned by an application using character recognition software to determine if source file 123 includes a ‘©’ symbol. One possible source of values for attributes such as attributes 217, 219, 221 and 227 is metadata stored in the form of object 200 within or in conjunction with source file 123. In a similar fashion, other information can be collected by means of a scanning procedure. In addition, values can be determined either programmatically or via a GUI that automatically pops up on display 103 (FIG. 1) and queries the user for the required information. Such a GUI may also enable the user to modify information already collected by other means.

It should be understood that object 200 is only one example of a memory object that may be used to implement the claimed subject matter. Other memory objects with fewer, more and/or different attributes and methods may be employed, particularly with regard to source files 123 and destination files 113 (FIG. 1) that differ from the text files 135 and 143 used as examples here.

FIG. 6 is a flowchart of a Copy Plus and Paste process 250 that implements the claimed subject matter. Process 250 starts in a “Begin Copy Plus and Paste” (CPP) step 251 and control proceeds immediately to a “Mark Target” step 253 in which a particular block, such as text_block_{—}2 139 (FIGS. 3 and 4), of a source document, such as document_{—}1 135 (FIGS. 2 and 3), is highlighted to identify the block as the target of an action 131 (FIGS. 2 and 3). One example of a highlighted block is text_block_{—}2 139, shown in FIGS. 3 and 4. Of course, the initiation of process 250 is predicated upon the assumption that a source file 123 (FIG. 1) has already been located and displayed on display 103 (FIG. 1).

From Mark Target step 253, control proceeds to a “Copy Target to Clipboard” step 255 in which a user initiates a copy of, in this example, text_block_{—}2 139 or some other content, to either a temporary file (not shown) in data store 111 (FIG. 1) or to random access memory (RAM) (not shown) in CPU 109 (FIG. 1). The copy is initiated by clicking either the Copy action or the Copy Plus action of action buttons 131 (FIGS. 2 and 3). Once the selected, or highlighted, content is copied to the clipboard, control proceeds to a “Copy Plus?” step 257 in which process 250 whether the copy to clipboard was initiated by the Copy action or the Copy Plus action. If initiated by the Copy action, control proceeds to a “Select Destination” step 261 in which the user displays a target document, in this example document_{—}2 143, on screen 103 (FIG. 1). If the copy is initiated by the Copy Plus action, then control proceeds from step 257 to a “Collect Metadata” step 259 in which a ClipMetadata object 200 (FIG. 5) is created and collectMetadata method 241 (FIG. 5) is called to populate attributes 207, 209, 211, 213, 215, 217, 219, 221, 223, 225, 227, 229, 231, 233 and 235 (FIG. 5) that have information associated with them at this point in process 250. For example, process 250 can determine dateTimeCapture attribute 209 but will still not have knowledge of dateTimePasted attribute 223. Following step 259, control proceeds to Select Destination step 251 where processing proceeds as explained above.

Following step 261, control proceeds to a “Paste to Destination” step 263 in which the user positions the cursor (not shown) at a target location in the destination document, in this case document_{—}2 143, and the content copied to the clipboard in step 255 is pasted into document_{—}2 145 at the current position of the cursor. Control then proceeds to a “Copy Plus?” step 265 in which, as in step 247, process 250 determines whether the copy initiated in step 255 was a Copy action or a Copy Plus action. If the copy executed in step 255 was a Copy step, then control proceeds to a “End CP&P” step 299 in which process 250 is complete. If the copy executed in step 255 was the Copy Plus action, then control proceeds from step 265 to a “Collect Metadata” step 267 in which collectMetadata method 241 is called again to fill in the attributes 207, 209, 211, 213, 215, 217, 219, 221, 223, 225, 227, 229, 231, 233 and 235 that remained unfilled after completion of step 259.

Once all relevant metadata has been collected in steps 259 and 267, control proceeds to a “Store Metadata” step 269 in which ClipMetadataObject 200 created in step 259 and populated in steps 259 and 267 is stored in data store 111. As explained above in the Summary, metadata can be stored in document_{—}2 143, either in non-viewable areas or in viewable areas, such as in a footnote. In the alternative, metadata object 200 can be stored in a separate, correlated document, e.g. a separate document having the same name as the destination document but with a different file extension that identifies the contents of the separate document as containing metadata. Finally, after the metadata object 200 is stored in memory, control proceeds to End CP&P step 299 in which process 250 is complete.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified steps performed in the same or a different order.

1. A method for tracking metadata related to an information object inserted into a document, the method comprising the steps of:
compiling metadata describing an information object collected from a source document;
storing the metadata and the corresponding information object in a memory; and
inserting the metadata into a first destination document when the information object is inserted into the first destination object.

2. The method of claim 1, wherein the first destination document is a word processing document.

3. The method of claim 1, wherein the information object is computer source code.

4. The method of claim 1, wherein the metadata includes information providing attribution for the information object.

5. The method of claim 1, wherein the metadata includes information related to the source document.

6. The method of claim 1, further comprising the step of inserting the metadata into a second destination document rather than the first destination document, wherein the second destination document is associated with the first destination document.

7. The method of claim 1, wherein the metadata is not viewable during at least one processing phase of the first destination document.

8. A system for tracking metadata related to an information object inserted into a document, comprising:
a computing system;
a source document;
a first destination document;
an information object collected from the source document;
a metadata object describing the information object; and
logic, executed on the computing system, for inserting the metadata object into the first destination document when the information object is inserted into the first destination object.

9. The system of claim 8, wherein the first destination document is a word processing document.

10. The method of claim 8, wherein the information object is computer source code.

11. The method of claim 8, wherein the metadata object includes information providing attribution for the information object.

12. The method of claim 8, wherein the metadata object includes information related to the source document.

13. The method of claim 8, further comprising:
a second destination document correlated to the first destination document; and
logic for inserting the metadata into the second destination document rather than the first destination document.

14. The method of claim 8, wherein the metadata object is not viewable during at least one processing phase of the first destination document.

15. A computer program product for tracking metadata related to an information object inserted into a document, comprising:
a recording medium;
means, stored on the recording medium, for compiling metadata describing an information object collected from a source document;
means, stored on the recording medium, for storing the metadata and the corresponding information object in a memory; and
means, stored on the recording medium, for inserting the metadata into a first destination document when the information object is inserted into the first destination object.

16. The computer programming product of claim 15, wherein the first destination document is a word processing document.

17. The computer programming product of claim 15, wherein the information object is computer source code.

18. The computer programming product of claim 15, wherein the metadata includes information providing attribution for the information object.

19. The computer programming product of claim 15, wherein the metadata includes information related to the source document.

20. The computer programming product of claim 15, further comprising means, stored on the recording medium, for inserting the metadata into a second destination document rather than the first destination document, wherein the second destination document is associated with the first destination document.

21. A method for compiling and storing metadata, comprising the steps of:
compiling metadata corresponding to an information object collected from a source document, wherein the metadata is information related the information object;
inserting the information object into a first destination document; and
storing the metadata in conjunction with the first destination document, such that the metadata can be correlated with the information object.

22. The method of claim 21, wherein the metadata is information related to the source of the information object.

23. The method of claim 21, wherein the metadata is stored in the first destination document.

24. The method of claim 21, wherein the metadata is stored in a second destination document such that the second destination document can be correlated with the first destination document.

25. A method of accessing metadata and associating the metadata with an information object, comprising the steps of:
accessing a first document; and
retrieving a metadata object, stored in conjunction with the first document and associated with an information object included in the first document, wherein the metadata object includes information relating to the source of the information object.
